(19) United States
(12) Patent Application Publication
(10) Pub. No.: US 2026/0080462 A1
(43) Pub. Date: Mar. 19, 2026

(54) PRODUCT SELECTION AND DISPLAY SYSTEMS AND METHODS

(71) Applicant: Lowe's Companies, Inc., Mooresville, NC (US)

(72) Inventors: Philip Ashton Harlow, Bothell, WA (US); Stephen Gregory Lindgren, Cornelius, NC (US); Coard Elliott Miller, Charlotte, NC (US); Deane McGahan, Shoreline, WA (US)

(21) Appl. No.: 19/329,184

(22) Filed: Sep. 15, 2025

Related U.S. Application Data
(60) Provisional application No. 63/695,035, filed on Sep. 16, 2024.

(51) Int. Cl. G06Q 30/0601; G06F 3/01

(52) U.S. Cl. CPC G06Q 30/06433; G06F 3/011; G06F 3/017

(57) ABSTRACT

Product selection and display system and methods of facilitating product selection are disclosed. A product selection and display system includes a product display system (PDS) and a companion device. The companion device is configured to display product selection options via the companion device, receive companion device input designating one or more product selections, and generate and transmit one or more companion device product collection model control commands in response to the companion device input. The PDS is configured to display a PDS display device view of a product collection model, receive PDS input designating one or more PDS user product selections, and configure the product collection model from selected product models.

### CROSS REFERENCE TO RELATED APPLICATIONS

This application claims the benefit of U.S. Provisional Ser. No. 63/695,035, filed Sep. 16, 2024, the entire contents of which are hereby incorporated by reference for all purposes in its entirety.

### BACKGROUND

Image displays have been utilized in different mixed reality systems such as augmented reality systems that include near eye displays and heads-up displays. In a mixed reality system, an image can be displayed to a user from a light projector onto a light transparent display that allows the user to also view the real world.

### BRIEF SUMMARY

The following presents a simplified summary of some product selection and display systems and methods of facilitating product selection of the present disclosure to provide a basic understanding of the product selection and display systems and methods of facilitating product selection. This summary is not an extensive overview of the product selection and display systems and methods of facilitating product selection of the present disclosure. It is not intended to identify key/critical elements of the product selection and display systems and methods of facilitating product selection of the present disclosure or to delineate the scope of the product selection and display systems and methods of facilitating product selection of the present disclosure. Its sole purpose is to present some product selection and display systems and methods of facilitating product selection of the present disclosure in a simplified form as a prelude to the more detailed description that is presented later.

Examples described herein are directed to product selection and display systems and methods of facilitating product selection. A product selection and display system can include a product display system (PDS) and a companion device. The PDS can include a PDS display device configured for use by a customer to view virtual representations of a product collection model made up of models of a collection of products. The companion device can be used by a salesperson to facilitate viewing and selection of the collection of products by the customer. The PDS display device can be configured to be operable by the customer to select the products in the collection of products and/or the companion device can be configured to be operable by the customer to select the products in the collection of products, thereby enabling a collaborative effort between the customer and the salesperson during a product selection and display session.

Thus, in one aspect, a product selection and display system includes a companion device and a product display system (PDS). The companion device includes a companion device display, one or more companion device processors, and one or more companion device storage media storing companion device instructions. The companion device instructions are executable by the one or more companion device processors to cause the companion device to: (a) display product selection options via the companion device, (b) receive companion device input designating one or more product selections via the companion device, and (c) generate and transmit one or more companion device product collection model control commands in response to the companion device input designating one or more product selections. The PDS includes a PDS display device, one or more PDS storage media storing PDS instructions, and one or more PDS processors. The PDS display device includes a PDS display. The PDS instructions are executable by the one or more PDS processors to cause the PDS to: (a) display a PDS display device view of a product collection model that includes a selection of products on the PDS display, (b) receive PDS input designating one or more PDS user product selections via the PDS display device, and (c) configure the product collection model from selected product models. Each of the selected product models can be selected from a corresponding set of product models based on the PDS input designating one or more PDS user product selections and the one or more companion device product collection model control commands so that each of the companion device and the PDS display device can be used to independently configure the product collection model.

The product selection and display system can communicatively couple the companion device and the PDS using any suitable approach. For example, the product selection and display system can employ a persistent, bidirectional communication channel between the companion device and the PDS. WebSocket is a communication protocol that can be used to communicatively couple the companion device and the PDS. WebSocket provides full duplex, stateful communication channels over a single, persistent TCP connection. The companion device and the PDS can be communicatively coupled via a WebSocket server. The companion device instructions can be executable by the one or more companion device processors and the PDS instructions can be executable by the one or more PDS processors to implement a pairing process by which the companion device and the PDS are communicatively coupled.

The product selection and display system can be configured to determine a viewed location in the PDS display device view of the product collection model display an indication of the viewed location via the companion device to inform the salesperson of the viewed location. For example, the PDS instructions can be executable by the one or more PDS processors to: (a) generate eye tracking data indicative of a view direction of a user of the PDS display device, (b) process the eye tracking data to generate viewed location data indicating a viewed location and/or a viewed product of the product collection model being viewed by the user of the PDS display device, and (c) transmit the viewed location data to the companion device. The companion device instructions can be executable by the one or more companion device processors to display an indication of the viewed location and/or the viewed product of the product collection model by the companion device display. The companion device instructions can be executable by the one or more companion device processors to: (a) display a companion device view of the product collection model on the companion device display; and (b) display the indication of the viewed location and/or the viewed product of the product collection model in the companion device view. The companion device instructions can be executable by the one or more companion device processors to display the indication of the viewed product of the product collection model on the companion device display.

The product selection and display system can be configured to display an indication of a product selected via the PDS display device on the companion device display For example, the PDS instructions can be executable by the one or more PDS processors to: (a) generate selected product data indicative of a selected product of the product collection model selected by a user of the PDS display device, and (b) transmit the selected product data to the companion device. The companion device instructions can be executable by the one or more companion device processors to display an indication of the selected product by the companion device display.

The PDS instructions can be executable by the one or more PDS processors to generate product collection model image data for the product collection model. The PDS instructions can be executable by the one or more PDS processors to transmit the product collection model image data to the companion device for use in displaying the companion device view of the product collection model on the companion device display.

The product selection and display system can be configured to display indications of selectable products of the product collection model via the companion device and/or the PDS display device. For example, the PDS instructions can be executable by the one or more PDS processors to transmit selectable product indication data indicating, for each selectable product of the product collection model, selectable products of the product collection model to the companion device. The companion device instructions can be executable by the one or more companion device processors to display indications of the selectable products of the product collection model on the companion device display. The PDS instructions can be executable by the one or more PDS processors to display indications of selectable products of the product collection model in the PDS display device view of the product collection model.

The product selection and display system can be configured for selection and display of any suitable combination of products. For example, the product collection model can include at least two models of one or more kitchen cabinets, one or more countertops, one or more sink models, one or more faucets, one or more backsplashes, one or more floorings, one or more kitchen appliances, one or more cooktops, one or more drawer handles, one or more cabinet handles, or one or more paint or wall décor options.

The product selection and display system can be configured to be operable to save a selected configuration of the product collection model. For example, the companion device instructions can be executable by the one or more companion device processors to transmit product selection data for the product collection model for storage in a data storage device and in association with a customer account.

The product selection and display system can be configured to be operable to display product price and/or product descriptive data for a selected product of the product collection model. For example, the companion device instructions can be executable by the one or more companion device processors to access and display price and descriptive data on the companion device display for a selected product of the product collection model. The companion device instructions can be executable by the one or more companion device processors to transmit a price and descriptive data display command that causes display of the price and descriptive data on the PDS display device for the selected product. The PDS instructions can be executable by the one or more PDS processors to display the price and descriptive data for the selected product on the PDS display device in response to the price and descriptive data display command.

The product selection and display system can further include a mirroring device for use by the salesperson and/or a second customer. The mirroring device can include a mirroring device display, one or more mirroring device processors, and one or more mirroring device storage media storing mirroring device instructions. The mirroring device instructions can be executable by the one or more mirroring device processors to cause the mirroring device to display a mirroring device view of the product collection model on the mirroring device display.

The product selection and display system can communicatively couple the mirroring device and the PDS using any suitable approach. For example, the product selection and display system can employ a persistent, bidirectional communication channel between the mirroring device and the PDS. The mirroring device and the PDS can be communicatively coupled via a WebSocket server. The mirroring device instructions can be executable by the one or more mirroring device processors and the PDS instructions can be executable by the one or more PDS processors to implement a pairing process by which the mirroring device and the PDS are communicatively coupled.

The product selection and display system can be configured to provide image data to the companion device for use in displaying a companion device view of the product collection model and/or to provide image data to the mirroring device for use in displaying a mirroring device view of the product collection model. For example the PDS instructions can be executable by the one or more PDS processors to: (a) generate product collection model image data for the product collection model and (b) transmit the product collection model image data to the companion device for use in displaying the companion device view of the product collection model on the companion device display. The PDS instructions can be executable by the one or more PDS processors to: (a) generate product collection model image data for the product collection model and (b) transmit the product collection model image data to the mirroring device for use in displaying the mirroring device view of the product collection model on the mirroring device display.

The mirroring device can be configured to be operable to select the products in the product collection model. For example, the mirroring device instructions can be executable by the one or more mirroring device processors to cause the mirroring device to: (a) receive mirroring device input designating one or more product selections, and (b) generate and transmit one or more mirroring device product collection model control commands in response to the mirroring device input designating one or more product selections. The PDS instructions can be executable by the one or more PDS processors to: (a) receive the mirroring device product collection model control commands, and (b) select each product of the selection of products in the product collection model from the corresponding set of product models based on the companion device product collection model control commands, the PDS input designating one or more PDS user product selections, and the mirroring device product collection model control commands so that each of the companion device, the PDS display device, and the mirroring device can be used to independently configure the product collection model.

The product selection and display system can be configured to display indications of selectable products of the product collection model in the mirroring device view. For example, the PDS instructions can be executable by the one or more PDS processors to transmit selectable product indication data indicating, for each selectable product of the product collection model, selectable products of the product collection model to the companion device and/or the mirroring device. The PDS instructions can be executable by the one or more PDS processors to display indications of the selectable products of the product collection model in the PDS display device view. The mirroring device instructions can be executable by the one or more mirroring device processors to display indications of the selectable products of the product collection model in the mirroring device view. The companion device instructions can be executable by the one or more companion device processors to display indications of the selectable products of the product collection model on the companion device display.

The product selection and display system can be configured to be operable to selectively change the viewpoint of the PDS display device view of the product collection model. For example, the PDS instructions can be executable by the one or more PDS processors to change a viewpoint of the PDS display device view of the product collection model based on an PDS display device viewpoint instruction to change the viewpoint received via the PDS display device or a companion device viewpoint instruction to change the viewpoint received via the companion device.

The PDS display device can include a mixed reality system (MRS) headset. The MRS headset can include an MRS headset display configured to display the PDS display device view of the product collection model. The MRS headset can include one or more image sensors configured to image a hand of a user of the MRS headset to generate corresponding hand image data. The PDS instructions can be executable by the one or more PDS processors to: (a) process the hand image data to monitor for a finger snap of the user of the MRS headset, and (b) generate an input command in response to detecting the finger snap of the user of the MRS headset.

In another aspect, a method of facilitating product selection is provided. The method includes: (a) displaying, by a companion device, product selection options via a companion device display of the companion device, (b) receiving companion device input designating one or more product selections via the companion device, (c) generating and transmitting, by the companion device, one or more companion device product collection model control commands in response to the companion device input designating one or more product selections, (d) displaying, by a product display system (PDS) display device of a PDS, a PDS display device view of a product collection model of a selection of products, (e) receiving PDS input designating one or more PDS display device user product selections via the PDS display device, and (f) configuring the product collection model from selected product models, wherein each of the selected product models is selected from a corresponding set of product models based on the PDS input designating one or more PDS display device user product selections and the one or more companion device product collection model control commands so that each of the companion device and the PDS display device can be used to independently configure the product collection model.

The method can include communicatively coupling the companion device and the PDS using any suitable approach. For example, the companion device and the PDS can be communicatively coupled via a persistent, bidirectional communication channel between the companion device and the PDS. WebSocket is a communication protocol that can be used in the method to communicatively couple the companion device and the PDS. The companion device and the PDS can be communicatively coupled via a WebSocket server in the method. The method can include communicatively pairing the companion device and the PDS.

The method can include displaying an indication of a location and/or a viewed product of the product collection model on the companion device display. For example, the method can include: (a) generating, via the PDS display device, eye tracking data indicative of a view direction of a user of the PDS display device, (b) processing, by the PDS, the eye tracking data to generate viewed location data indicating a viewed location and/or a viewed product of the product collection model being viewed by the user of the PDS display device, (c) transmitting the viewed location data to the companion device, and (d) displaying an indication of the viewed location and/or the viewed product of the product collection model on the companion device display. The method can include: (a) displaying a companion device view of the product collection model on the companion device, and (b) displaying the indication of the viewed location and/or the viewed product of the product collection model in the companion device view. The method can include displaying the indication of the viewed product of the product collection model on the companion device.

The method can include displaying an indication of a product selected via the PDS display device on the companion device display. For example, the method can include: (a) generating selected product data indicative of a selected product of the product collection model selected by a user of the PDS display device, (b) transmitting the selected product data to the companion device, and (c) displaying an indication of the selected product by the companion device display.

The method can include generating, by the PDS, product collection model image data for the product collection model. The method can include transmitting, by the PDS, the product collection model image data to the companion device for use in displaying the companion device view of the product collection model on the companion device.

The method can include displaying indications of selectable products of the product collection model via the companion device and/or the PDS display device. For example, the method can include: (a) transmitting, by the PDS, selectable product indication data indicating, for each selectable product of the product collection model, selectable products of the product collection model to the companion device, and (b) displaying indications of the selectable products of the product collection model on the companion device. The method can include displaying indications of selectable products of the product collection model in the PDS display device view of the product collection model.

The method can be used for selection and display of any suitable combination of products. For example, the product collection model can include at least two models of one or more kitchen cabinets, one or more countertops, one or more sink models, one or more faucets, one or more backsplashes, one or more floorings, one or more kitchen appliances, one or more cooktops, one or more drawer handles, one or more cabinet handles, or one or more paint or wall décor options.

The method can include saving a selected configuration of the product collection model. For example, the method can include transmitting product selection data for the product collection model for storage in a data storage device and in association with a customer account.

The method can include displaying product price and/or product descriptive data for a selected product of the product collection model. For example, the method can include accessing and displaying, by the companion device, price and descriptive data on the companion device for a selected product of the product collection model. The method can include: (a) transmitting, by the companion device, a price and descriptive data display command that causes display of the price and descriptive data on the PDS display device for the selected product; and (b) displaying the price and descriptive data for the selected product on the PDS display device in response to the price and descriptive data display command.

The method can include displaying a mirroring device view of the product collection model on a mirroring device. The method can include: (a) generating, by the PDS, product collection model image data for the product collection model, (b) transmitting, by the PDS, the product collection model image data to the companion device for use in displaying the companion device view of the product collection model on the companion device, and (c) transmitting, by the PDS, the product collection model image data to the mirroring device for use in displaying the mirroring device view of the product collection model on the mirroring device. The mirroring device and the PDS are communicatively can be coupled via a WebSocket server. The method can include communicatively pairing the mirroring device and the PDS.

The method can include selecting the products in the product collection model via the mirroring device. For example, the method can include: (a) receiving mirroring device input designating one or more product selections via the mirroring device, (b) generating and transmitting one or more mirroring device product collection model control commands in response to the mirroring device input designating one or more product selections, (c) receiving, by the PDS, the one or more mirroring device product collection model control commands, and (d) selecting, by the PDS, each product of the selection of products in the product collection model from the corresponding set of product models based on the one or more companion device product collection model control commands, the PDS input designating one or more PDS display device user product selections, and the one or more mirroring device product collection model control commands so that each of the companion device, the PDS display device, and the mirroring device is operable to independently configure the product collection model.

The method can include displaying indications of selectable products of the product collection model in the mirroring device view. For example, the method can include: (a) transmitting, by the PDS, selectable product indication data indicating, for each selectable product of the product collection model, selectable products of the product collection model to the companion device and the mirroring device, (b) displaying indications of the selectable products of the product collection model in the PDS display device view, (c) displaying indications of the selectable products of the product collection model in the mirroring device view, and (d) displaying indications of the selectable products of the product collection model on the companion device.

The method can include selectively changing the viewpoint of the PDS display device view of the product collection model. For example, the method can include changing, by the PDS, a viewpoint of the PDS display device view of the product collection model based on a PDS display device viewpoint instruction to change the viewpoint received via the PDS display device or a companion device viewpoint instruction to change the viewpoint received via the companion device.

In this method, the PDS display device can include a mixed reality system (MRS) headset. The MRS headset can include an MRS headset display configured to display the PDS display device view of the product collection model. The MRS headset can include one or more image sensors configured to image a hand of a user of the MRS headset to generate corresponding hand image data. The method can include: (a) processing, by the PDS, the hand image data to monitor for a finger snap of the user of the MRS headset, and (b) generating, by the PDS, an input command in response to detecting the finger snap of the user of the MRS headset.

A better understanding of the nature and advantages of the product selection and display systems and methods of facilitating product selection of the present disclosure may be gained with reference to the following detailed description and accompanying drawings.

### BRIEF DESCRIPTION OF THE DRAWINGS

FIG. 1 shows a simplified schematic diagram of a product selection and display system, in accordance with the present disclosure.

FIG. 2 shows a program navigation screen for the product display system (PDS) of the product selection and display system of FIG. 1, in accordance with the present disclosure.

FIG. 3 shows a start screen for the PDS of the product selection and display system of FIG. 1, in accordance with the present disclosure.

FIG. 4 shows a settings selection screen for the PDS of the product selection and display system of FIG. 1, in accordance with the present disclosure.

FIG. 5 shows a user interface screen for the PDS of the product selection and display system of FIG. 1, in accordance with the present disclosure.

FIG. 6 shows a viewed location selection screen for the PDS of the product selection and display system of FIG. 1, in accordance with the present disclosure.

FIG. 7 shows a selected location view screen for the PDS of the product selection and display system of FIG. 1, in accordance with the present disclosure.

FIG. 8 shows a connection prompt screen for the companion device of the product selection and display system of FIG. 1, in accordance with the present disclosure.

FIG. 9 shows a pairing selection screen for the companion device of the product selection and display system of FIG. 1, in accordance with the present disclosure.

FIG. 10 shows a start screen for the companion device of the product selection and display system of FIG. 1, in accordance with the present disclosure.

FIG. 11 shows the start screen of FIG. 10 with an options menu displayed, in accordance with the present disclosure.

FIG. 12 shows the start screen of FIG. 10 with a talking points displayed, in accordance with the present disclosure.

FIG. 13 shows a product collection selection screen for the companion device of the product selection and display system of FIG. 1, in accordance with the present disclosure.

FIG. 14 shows a product style selection screen for the companion device of the product selection and display system of FIG. 1, in accordance with the present disclosure.

FIG. 15 shows a customization start screen for the companion device of the product selection and display system of FIG. 1, in accordance with the present disclosure.

FIG. 16 shows a product selection screen with an options menu displayed for the companion device of the product selection and display system of FIG. 1, in accordance with the present disclosure.

FIG. 17 shows a product selection screen with the backsplash selected for the companion device of the product selection and display system of FIG. 1, in accordance with the present disclosure.

FIG. 18 shows a product selection screen with the faucet selected for the companion device of the product selection and display system of FIG. 1, in accordance with the present disclosure.

FIG. 19 shows a product selection screen with price and descriptive information for the faucet selected in FIG. 18, in accordance with the present disclosure.

FIG. 20 shows a saved product selections screen for the companion device of the product selection and display system of FIG. 1, in accordance with the present disclosure.

FIG. 21 shows a view screen showing a product collection model of selected products for the companion device of the product selection and display system of FIG. 1, in accordance with the present disclosure.

FIG. 22 shows selectable product icons for currently selected products in the product collection model for the companion device of the product selection and display system of FIG. 1, in accordance with the present disclosure.

FIG. 23 shows a simplified schematic diagram illustrating an example configuration for the companion device and the mirroring device of the product selection and display system of FIG. 1, in accordance with the present disclosure.

### DETAILED DESCRIPTION

Product selection and visualization systems and methods of the present disclosure accommodate collaboration between a product specialist (e.g., a salesperson) and one or more customers to facilitate product selection and visualization. A product selection and visualization system of the present disclosure can include a product display system (PDS), a companion device, and optionally one or more mirroring devices. The PDS can include a PDS display device. The PDS can be used to execute virtual design software while being in communication with the companion device (and optionally with one or more mirroring devices when employed) to support effective and efficient collaboration between a customer using/operating the PDS display device and a product specialist using/operating the companion device.

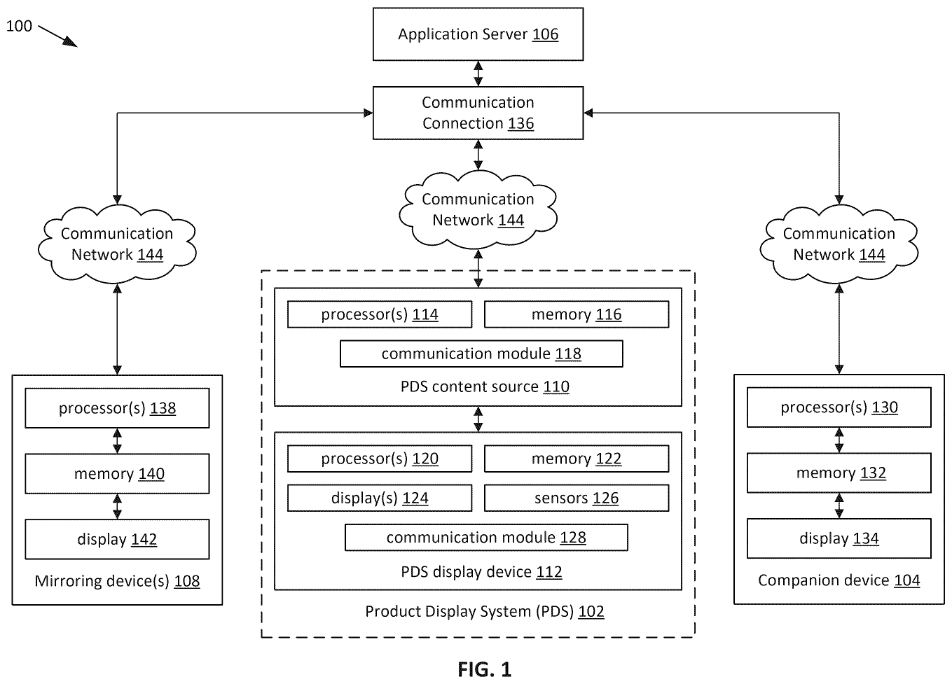

Turning now to the drawing figures in which similar reference identifiers refer to similar items, FIG. 1 shows a simplified schematic diagram of a product selection and display system 100, in accordance with the present disclosure. The product selection and display system 100 includes a product display system (PDS) 102, a companion device 104, an application server 106, and optionally one or more mirroring devices 108. A communication connection 136 is communicatively connected to each of the PDS 102, the companion device 104, the application server 106, and the mirroring device(s) 108.

The PDS 102 includes a PDS content source 110 and a PDS display device 112. The PDS content source 110 includes one or more PDS content source processors 114, a PDS content source memory 116, and a PDS content source communication module 118. The PDS content source memory 116 can store PDS content source instructions executable by the PDS content source processor(s) 114 to cause the PDS content source 110 to function as described herein. The PDS display device 112 includes one or more PDS display device processors 120, a PDS display device memory 122, one or more PDS display device displays 124, one or more PDS display device sensors 126, and a PDS display device communication module 128. The PDS display device memory 122 can store PDS display device instructions executable by the PDS display device processor(s) 120 to cause the PDS display device 112 to function as described herein. The one or more PDS display device displays 124 are operable to display images to a user of the PDS display device including, but not limited to, a graphical user interface (GUI) for the PDS 102. The GUI for the PDS 102 can display images of a product collection model, selection options for configuring the product collection module, and price and descriptive data for candidate products for selective including in the product collection model. The PDS display device sensor(s) 126 can be configured to: (a) generate eye tracking output that can be processed by the PDS display processor(s) 120 to track a viewing direction of the user of the PDS display device 112 and (b) generate hand tracking output that can be processed by the PDS display processor(s) 120 to track hand movements of the user of the PDS display device 112 to monitor the hand movements for the occurrence of hand gestures for inputs to the PDS 102 by the user (e.g., a finger snap, a pinching gesture). The PDS display device communication module 128 and the PDS content source communication module 118 can be configured for wireless communication using any suitable wireless communication protocol to communicatively couple the PDS display device 112 and the PDS content source 110.

The companion device 104 includes one or more companion device processors 130, a companion device memory 132, and a companion device display 134. The companion device memory 132 can store companion device instructions executable by the companion device processor(s) 130 to cause the companion device 104 to function as described herein. The companion device 104 can be communicatively coupled with the PDS 102 via a communication network 144 and the communication connection 136.

The mirroring device 108 includes one or more mirroring device processors 138, a mirroring device memory 140, and a mirroring device display 142. The mirroring device memory 140 can store mirroring device instructions executable by the mirroring device processor(s) 138 to cause the mirroring device 108 to function as described herein. The mirroring device 108 can be communicatively coupled with the PDS 102 via the communication network 144 and the communication connection 136.

The PDS 102 can be configured to display a user interface on the PDS display device 112. The user interface can display an image to a user of the PDS display device 112 of a product collection model. The user interface can also present a graphical user interface via which the user of the PDS display device 112 can input commands to the PDS 102 to control operation of the PDS 102 as described herein. The PDS display device 112 can include any suitable device operable to display an image to a user of the PDS display device 112 of a three-dimensional product collection model such as, but not limited to, a virtual reality headset, a mixed reality headset, a spatial computing headset, a tablet, a computer, or a mobile phone.

The product collection model can include a set of objects. The set of objects can include multi-dimensional objects such as three dimension objects and/or two dimensional objects. The objects can represent physical objects such as an object for sale (e.g., a chair, a lighting fixture, a fridge, a lamp, a tile, a backsplash, a countertop, flooring, a set of steps, a deck, a garage door, side paneling, rocks, flowers, a container, a dresser, a table, pillows, shades, etc.). The objects can have configurable attributes such as a style (e.g., modern, rustic, etc.), color, pattern, or material.

The PDS display device 112 can include a mixed reality headset operable to display an image of the product collection model to the user of the PDS display device 112. The mixed reality headset can be operable to accommodate viewing of the surrounding physical environment by the user of the mixed reality headset. The PDS display device display(s) 124 can include high-resolution displays for each eye configured to produce a stereoscopic 3D view of the product collection model. Alternatively, the PDS display device display(s) 124 can include a single high resolution display. The PDS display device 112 can include optical lenses positioned between the user's eyes and the display(s) 124 that are configured to magnify and align images displayed by the high-resolution displays for each eye. The sensors 126 can include any suitable image sensors and/or cameras for tracking orientation of the user's eyes and/or orientation and/or movement of the user's head. For example, the PDS display device 112 can be configured to track head movements in real-time through inertial measurement units (IMUs) containing gyroscopes, accelerometers, and/or magnetometers. The sensors 126 can include one or more outward-facing cameras that are used to capture the real world and overlay digital information on it, enhancing the user's perception of their environment. The sensors 126 can include depth sensors to measure spatial relationships and distances to map the environment. The sensors 126 can include a camera to monitor hand gestures of the user of the PDS display device 112 (e.g., pinching, snapping, clapping, waving, etc.). The PDS display device 112 can be configured to be operable to completely replace the user's real-world view with a virtual environment, such as a kitchen, a living room, a bedroom, a backyard, a front yard, a garage, a retail store, etc. The PDS 102 can be configured to enable a user to explore a virtual scene. For example, a viewpoint for a displayed virtual scene may be varied or changed in response to user input such as a motion sensor determining a user is moving, or a keyboard receiving input from the arrow keys.

The PDS display device 112 can be configured to sense or receive a user input. The PDS 102 can be configured to move, reorient, modify, replace, update, or otherwise modify one or more attributes of virtual objects in the product collection model in response to the user input. For example, the PDS 102 can be configured to cause the PDS display device 112 to display a user interface that displays selectable objects of the product collection model. Selection of one of the selectable objects (e.g., a backsplash object) can cause the user interface to display a set of options for the selected object (e.g., backsplashes that can be selected, backslash color, and/or backsplash tile colors and/or layouts). The PDS 102 can be configured to generate and transmit user input indications to the companion device 104 and/or the mirroring device(s) 108. For example, indications of a scene displayed by the PDS display device 112 can be transmitted to the companion device 104 and/or the mirroring device(s) 108.

The PDS 102 can receive an input from the companion device 104 or the mirroring device 108 that causes the PDS 102 to update the scene displayed by the PDS display device 112. The scene displayed by the PDS display device 112 can be updated to reflect a change(s) made to a scene, object, and/or menu of the companion device 104 or the mirroring device 108.

The PDS 102 can be communicatively coupled with companion device 104 and/or the mirroring device 108 through the communication connection 136. The PDS 102 and the companion device 104 can be configured for direct communication between the PDS 102 and the companion device 104 (e.g., via a communication cable, via wireless communication such as Wi-Fi and/or Bluetooth). Likewise, the PDS 102 and the mirroring device 104 can be configured for direct communication between the PDS 102 and the mirroring device 104 (e.g., via a communication cable, via wireless communication such as Wi-Fi and/or Bluetooth). When the communication connection 136 is employed, the communication connection 136 can be remote to the PDS 102, the companion device 104, and the mirroring device 108. The communication connection 136 can be configured to establish a dedicated communication session between the PDS 102 and the companion device 104 that provides for real time bi-directional data exchange. Likewise, the communication connection 136 can be configured to establish a dedicated communication session between the PDS 102 and the mirroring device 108 that provides for real time bi-directional data exchange. The communication connection 136 can be configured to be operable to establish any suitable number of dedicated communication sessions between the PDS 102 and each of one or more companion devices 104 and/or between the PDS 102 and each of one or more mirroring devices 108. Each of the dedicated communication sessions can be associated with scenes, objects, and/or menus presented by the PDS 102 via the PDS display device 112. The application server 106 can be configured to store the scenes, objects, menus, and/or other information presented by the PDS 102 via the PDS display device 112 or indicators of scenes, objects, menus, and/or other information presented by the PDS 102 via the PDS display device 112 for any suitable purpose (e.g., to reduce network traffic and/or storage requirements).

The mirroring device 108 can have any suitable configuration. For example, the mirroring device 108 can include a virtual reality headset, a mixed reality headset, a spatial computing headset, a tablet, a computer, or a mobile phone. The mirroring device 108 can be configured to display a scene. The scene displayed by the mirroring device 108 can be the same scene displayed by the PDS 102 via the PDS display device 112. For example, the mirroring device 108 can receive information about the scene displayed by the PDS 102 via the PDS display device 112 and use the received information to display the same scene via a display of the mirroring device 108. Accordingly, the mirroring device 108 can enable the user of the companion device 104 (e.g., a product specialist/salesperson) or an associate of the customer using the PDS display device 112 to see what the user of the PDS display device 112 sees. The companion device 104 can be configured to display the same scene displayed by the PDS 102 via the PDS display device 112 on the display(s) 124 (e.g., on a sub-portion of the display 134).

The companion device 104 can have any suitable configuration. For example, the companion device 104 can include a virtual reality headset, a mixed reality headset, a spatial computing headset, a tablet, a computer, or a mobile phone. The companion device 104 can display a scene. The scene displayed by the companion device 104 can be same scene displayed by the PDS 102 via the PDS display device 112 or can be related to the scene displayed by the PDS 102 via the PDS display device 112. For example, when the PDS 102 displays a 3D scene corresponding to a collection of 3D objects via the PDS display device 112, the companion device 104 can display a web page or an application page showing 2D objects corresponding to the 3D objects (e.g., that also represent the corresponding physical object) and options to edit, change, remove, add, replace any of the 2D objects (in which case, cause an update to the 3D scene and the corresponding 3D object(s)). The companion device 104 can present information indicative of the objects, scene(s), and/or user interfaces (e.g., menus), displayed by the PDS 102 via the PDS display device 112. For example, companion device 104 can present information indicating that a modern kitchen is being displayed by the PDS 102 via the PDS display device 112. In an example, companion device 104 can be configured to display information indicating that a menu is being presented by PDS 102 via the PDS display device 112. The displayed information can indicate which options are presented in the menu and enable the user of the companion device 104 to select one of the presented options. The selected option and/or other interactions with the user interface of the companion device 104 may cause information to be transmitted to the PDS 102 to cause scene(s), object(s), menu(s), and/or user interface elements displayed by the PDS 102 via the PDS display device 112 to be updated.

The PDS 102 can be configured to store a scene, objects, and object attributes in memory enabling the PDS 102 to display the scene including the objects with the attributes on a display of the PDS display device 112. The PDS 102 can be configured to send the scene, objects, and/or object attributes to the mirroring device(s) 108 and/or the companion device 104 to enable the mirroring device(s) 108 and/or the companion device 104 to display a scene, objects, and/or objects attributes that correspond with the scene, objects, and/or object attributes displayed by the PDS 102 via the PDS display device 112. If a change to the scene, objects, and/or object attributes are made on the PDS 102, the changed scene, objects, and/or object attributes may be transmitted to the mirroring device(s) 108 and/or the companion device 104 to reflect the change (e.g., on the display 142 of the mirroring device 106 and/or on the display 134 of the companion device 102). The companion device 104 can be configured so that, if a change is made to the scene, objects (e.g., one or more), and/or object attributes (e.g., of one or more objects) displayed by the companion device 102, the companion device 104 can transmit the changed scene, objects, and/or object attributes to the PDS 102 to update the scene, objects, and/or object attributes displayed by the PDS 102 via the PDS display device 112 to reflect the change.

The PDS 102, the companion device 104, and/or the mirroring device 108 can be configured so that, when a change is made to the scene, objects, and/or object attributes displayed by the PDS 102, the companion device 104, and/or the mirroring device 108, the scene, objects, and/or object attributes are not transmitted to other devices (e.g., the companion device 104, the PDS 102, and/or the mirroring device 108). Instead, the PDS 102, the companion device 104, and/or the mirroring device 108 can be configured to transmit an indication of the change to the other devices to enable the other devices to make the same change to the scene, objects, and/or object attributes stored by the respective devices. By transmitting the indication of the change, rather than the changed object, network traffic may be reduced, and latency may be reduced.

The application server 106 can be configured to store the scene, objects, and/or object attributes and the scene, objects, and/or object attributes can be transmitted to the PDS 102, the companion device 104, and the mirroring device 108 for respective displays of the scene, objects, and/or object attributes. The application server 106 can be configured to receive (and the PDS 102, the companion device 104, and the mirroring device 108 can be configured to transmit) indications of changes to scenes, objects (e.g., one or more), and/or object attributes (e.g., of one or more objects) and to transmit an indication of the changes and/or updated scenes, objects, and/or object attributes to the other devices (e.g., the PDS 102, the companion device 104, the mirroring device 108).

The scene, objects, and/or object attributes stored by the PDS 102, the application server 106, the companion device 104, and/or the mirroring device 108 can be associated with a user account and/or transmitted to any one or more of the other devices. For example, the application server 106 can store the scene, objects, and/or object attributes in memory and in association with the user account for future use and/or reference. The application server 106 can be configured to retrieve the scene, objects, and/or object attributes in memory and transmit the scene, objects, and/or object attributes to the PDS 102, the companion device 104, and/or the mirroring device 108 for further use and/or reference.

The system 100 can include any suitable number (e.g., 1, 2, 3, 4, or more) of the PDS 102, any suitable number of the companion device 104 (e.g., 1, 2, 3, 4, or more), and any suitable number of the mirroring device 108 (e.g., 1, 2, 3, 4, or more). Each of the devices 112, 104, 108 in the system 100 can display information (e.g., objects, scenes, attributes of objects) associated with the scene displayed by the PDS 102 via the PDS display device 112.

The PDS 102 can be configured so that, when the PDS display device 112 is moved, the scene displayed by the PDS display device 112 is updated to reflect the movement of the PDS display device 112. For example, when the PDS display device 112 is moved toward a virtual object in the displayed scene (e.g., by a user of the PDS display device 112 walking in the direction of the virtual object), the displayed scene is updated to move a viewpoint for the displayed scene toward the virtual object by a corresponding amount, thereby causing the object to appear to be closer to the user of the PDS display device 112). Accordingly, movement by the user of the PDS display device 112 can be employed by the user of the PDS display device 112 to vary the viewpoint of the scene in accordance with the user's viewing interests.

The PDS 102 can be configured to be operable to change the viewpoint of the scene displayed by the PDS display device 112 based on a user instruction to change the viewpoint without having to move the PDS display device 112. The instruction to change the viewpoint may be received as input from the user of the PDS display device 112 via a user interface displayed by the PDS 102 on the PDS display device 112 and/or received from the companion device 104. The PDS 102 can be configured to display a visual indicator that indicates a new location and orientation for the viewpoint (e.g., by presenting a viewpoint marker in the scene) for reference by the user of the PDS display device 112 to aid in the selection of the new location and orientation for the viewpoint. The PDS 102 can be configured to be operable to disable automatic updating of the location and orientation of the viewpoint of the scene responsive to movement of the PDS display device 112 when a non-default viewpoint of the scene is used. The PDS 102 can be configured to display a user interface element (such as a button stating “Exit Spectator Mode”) that can be selected to revert back to the default viewpoint for the scene.

The product selection and display system 100 can be configured to be operable to: (a) generate a document (e.g., a Portable Document Format (PDF) file) that shows a view of the product collection model and/or indicates products included in the product collection model and (b) transmit the document to another device. Any one or more of the application server 106, the PDS 102, the companion device 104, or the mirroring device 108 can be configured to generate and transmit the document to another device.

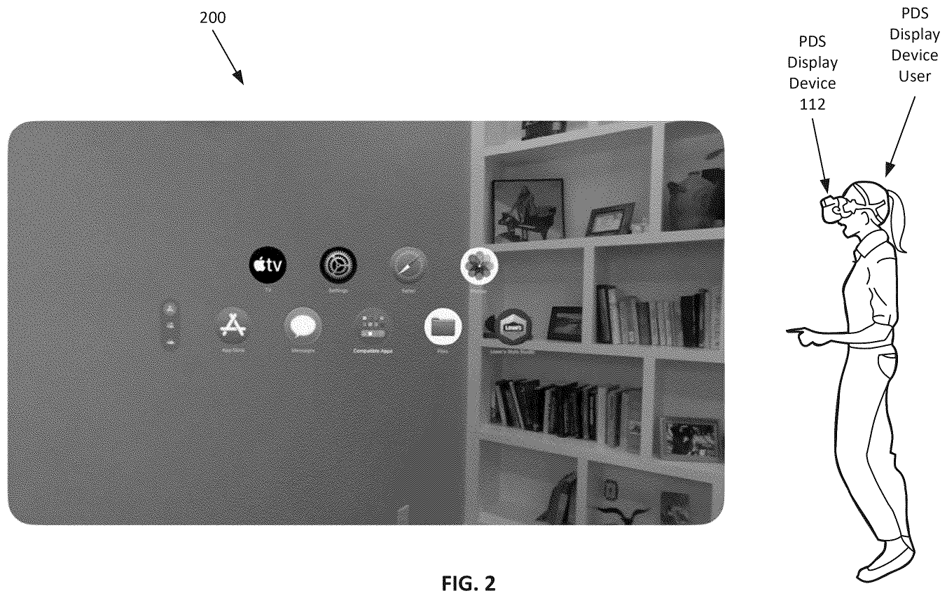

FIG. 2 shows a program navigation screen 200 for the PDS 102 that can be displayed on the PDS display device 112. The program navigation screen 200 includes a selectable icon 202 for running a product selection and display program by the PDS 102 to provide the functionality of the PDS 102 described herein.

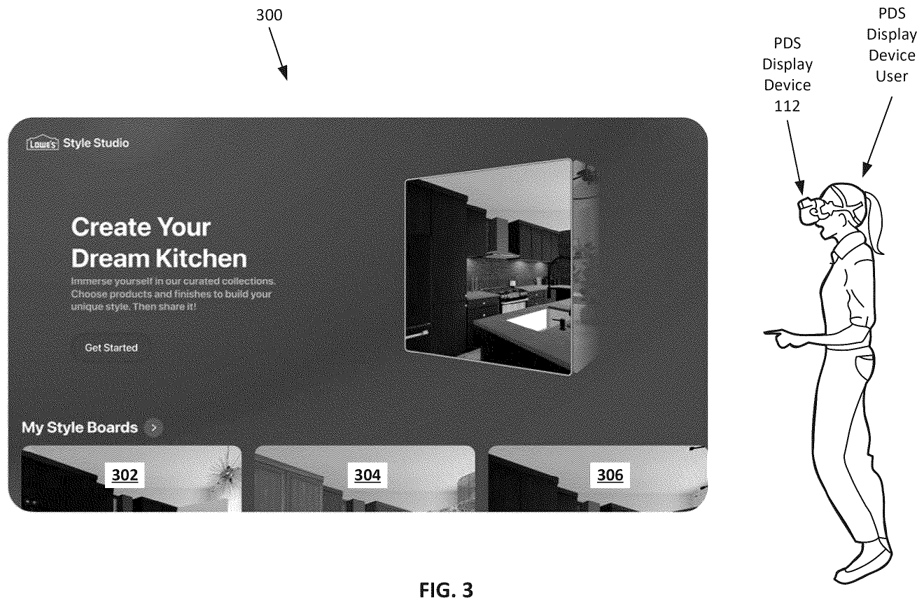

FIG. 3 shows a start screen 300 for the PDS 102 that can be displayed on the PDS display device 112. The start screen 300 includes selectable icons 302, 304, 306 for selecting an existing selection of products stored in a user account for the user of the PDS display device 112.

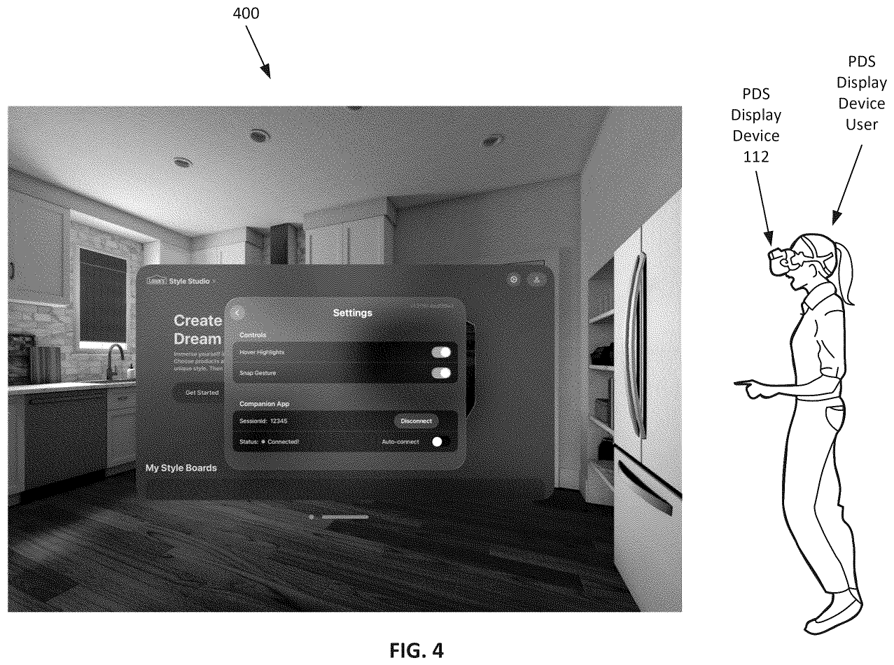

FIG. 4 shows a settings selection screen 400 for the PDS 102 that can be displayed on the PDS display device 112. The selection screen 400 is configured for selection of whether to enable or disable “hover highlights”, “snap gesture”, and “auto-connect”. When “hover highlights” is enabled, a location in the scene displayed by the PDS display device 112 that is being viewed by the user of the PDS display device 112 is highlighted via a localized increase in brightness. When “snap gesture” is enabled, the PDS 102 monitors for the occurrence of a finger snap by the user of the PDS display device 112 via processing of image data generated by a camera of the PDS display device 112 to a sequence of relative finger positions indicative of the user of the PDS display device 112 performing a finger snap. The finger snap can be used as a user input to the PDS 102 that can be used to select an object in the scene or graphical user interface displayed by the PDS display device. When “auto-connect” is enabled, the companion device 104 can be paired with the PDS 102 without further action by the user of the PDS display device 112. The settings selection screen 400 further includes a selectable “disconnect” button, which can be selected to disconnect the PDS 102 from the companion device 104.

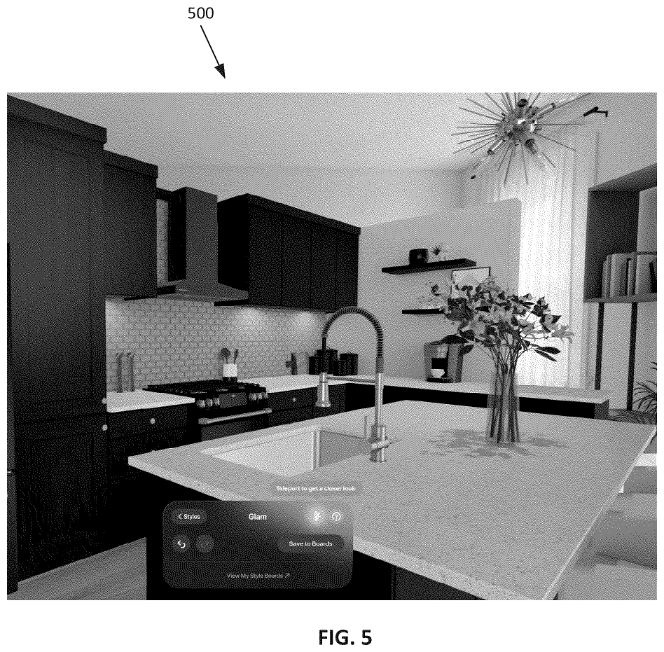

FIG. 5 shows a user interface screen 500 for the PDS 102 that can be displayed on the PDS display device 112. The user interface screen 500 is presenting a scene of a kitchen that includes a chair, counter tops, a backsplash, a light, a sink, a fridge, cabinets, and other assorted objects.

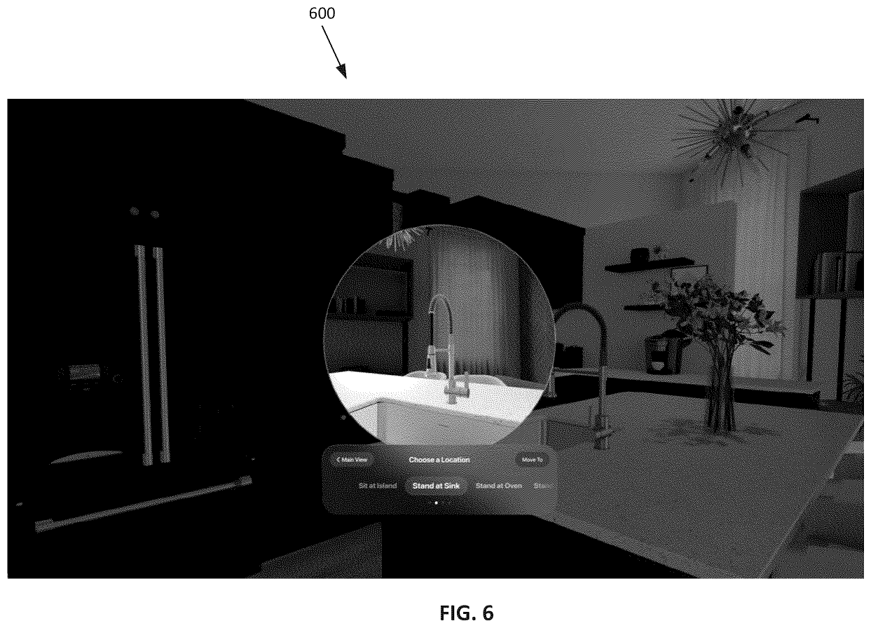

FIG. 6 shows a viewed location selection screen 600 for the PDS 102 that can be displayed on the PDS display device 112. The viewed location screen 600 shows an isolated view corresponding to a selectable viewpoint (i.e., “standing at sink”) for the displayed scene.

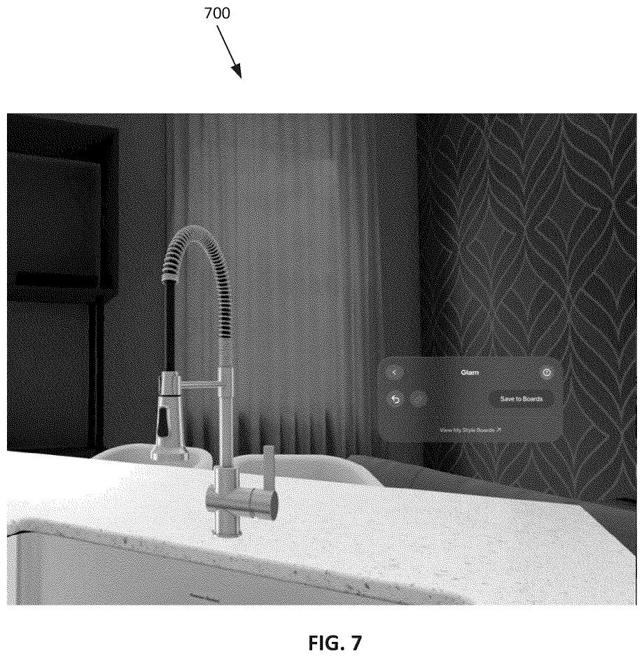

FIG. 7 shows a selected location view screen 700 for the PDS 102 that can be displayed on the PDS display device 112. The selected location view screen 700 shows the “standing at sink”view selectable via the viewed location selection screen 600 of FIG. 6.

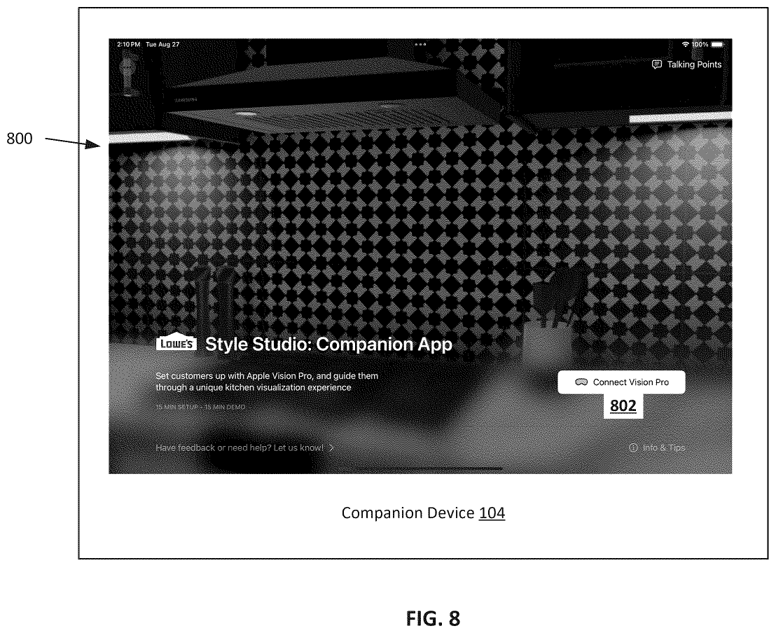

FIG. 8 shows a connection prompt screen 800 for the companion device 104 that can be displayed on the display 134 of the companion device 104. The connection prompt screen 800 includes a user interface element (e.g., the illustrated “Connect Vision Pro”) button 802 that initiates a process to communicatively connect the companion device 104 with the PDS 102.

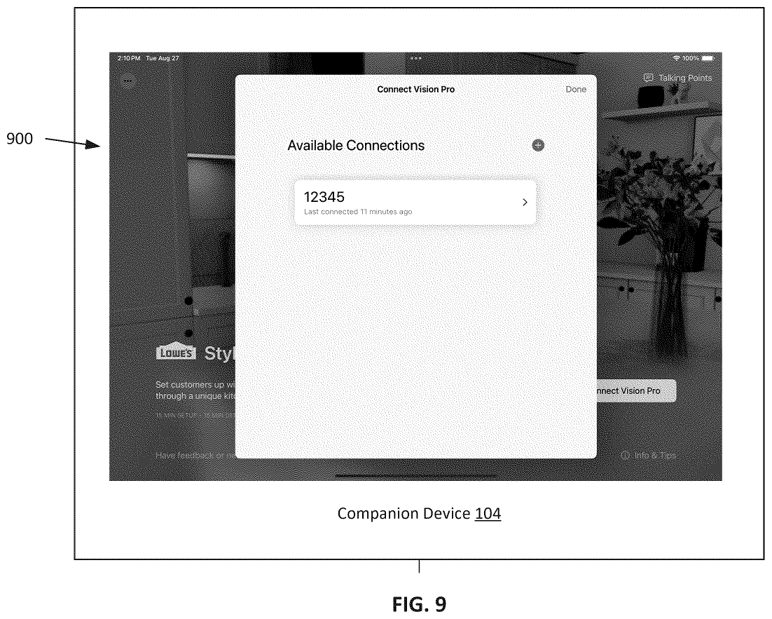

FIG. 9 shows a pairing selection screen 900 for the companion device 104 that can be displayed on the device 134 of the companion device 104. The pairing selection screen 900 can be displayed in response to selection of the “Connect Vision Pro” button 802 in the connection prompt screen 800 of FIG. 8. The pairing selection screen 900 displays a list PDSs 102 to which the companion device 104 can be communicatively connected (e.g., directly and/or indirectly (e.g., via a server, by the communication connection 124)). PDSs 102 that can be communicatively coupled with the companion device 102 may be PDSs 102 within a predefined distance, associated with the same user account as the companion device 104, associated with an identifier (e.g., owner identifier, store identifier, location identifier) of the companion device 104. The companion device 104 can be configured to accept user input of an identifier of each of one or more the PDSs 102 to which the companion device 104 can be communicatively coupled.

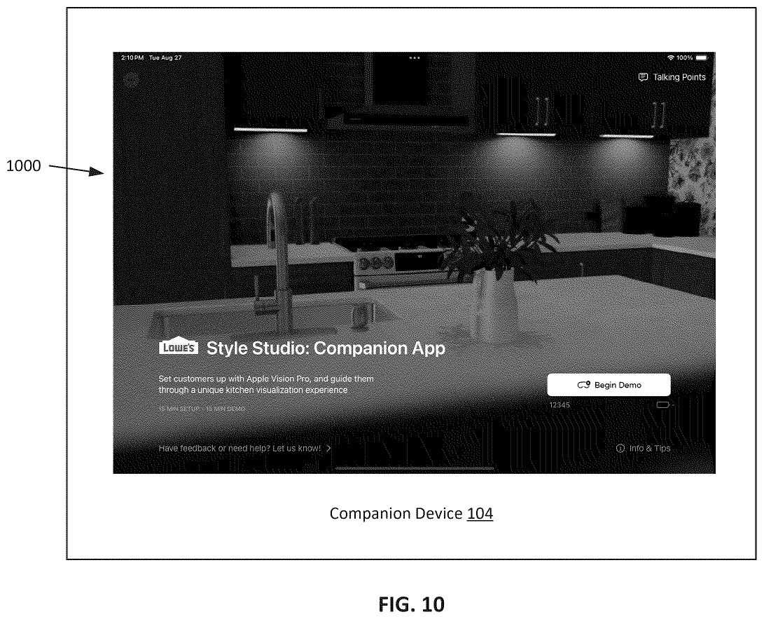

FIG. 10 shows a start screen 1000 for the companion device 104 that can be displayed on the device 134 of the companion device 104. The start screen 1000 can be displayed after the companion device 104 has established a communicative coupling with the applicable PDS 102.

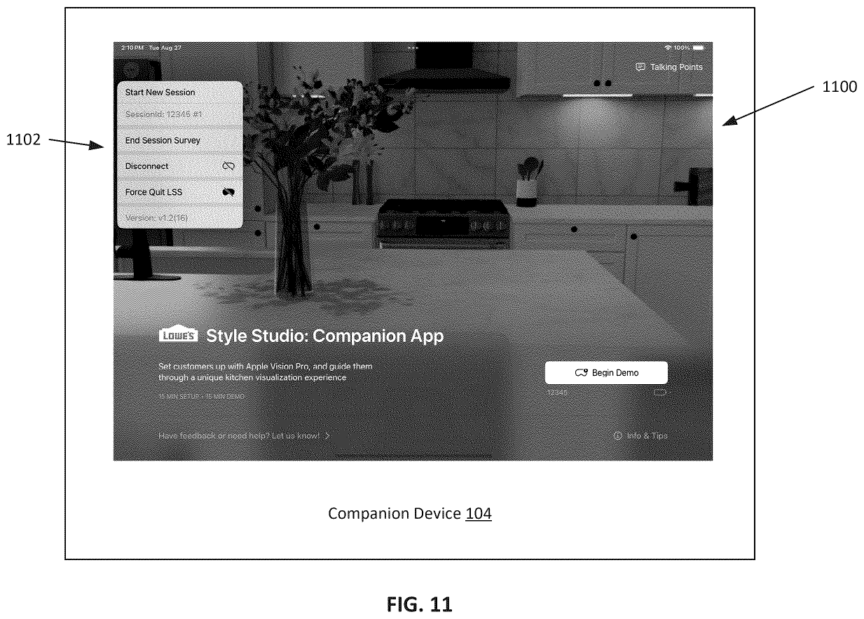

FIG. 11 shows the start screen 1100 with an options menu 1102 that can be displayed on the device 134 of the companion device 104. The options menu 1102 presents options that can be selected via user input. For example, a user of the companion device 104 can select respective input buttons to cause the companion device 104 to disconnect from the communication session established with the PDS 102, start a new session with another PDS 102, indicate a version of software running on the PDS 102, indicate a version of software running on the companion device 104, and/or cause the PDS 102 to exit an application. The companion device 104 and the PDS 102 can be configured so that the companion device can establish a first session with a first PDS 102 and a second session with a second PDS 102 and companion device 104 can navigate between the first session and the second session without disconnecting either session.

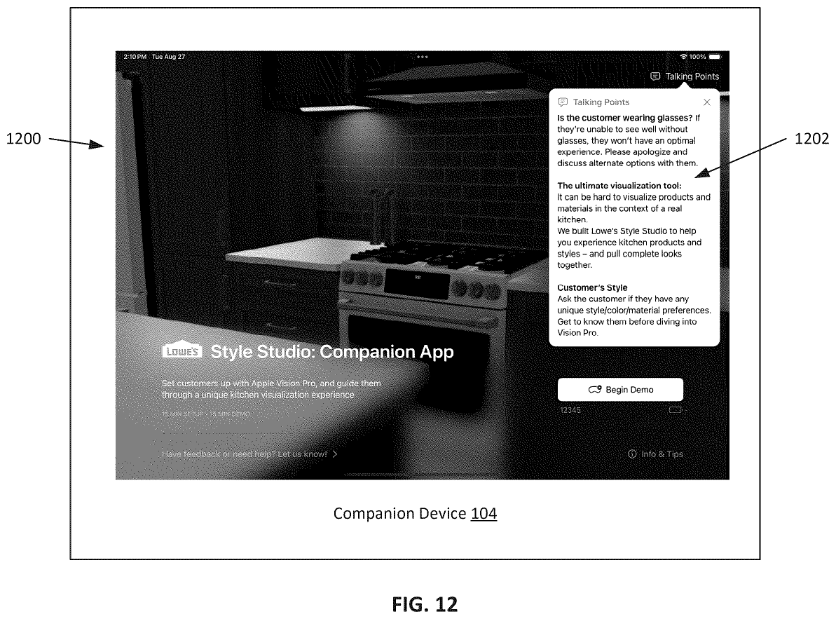

FIG. 12 shows the start screen 1200 with talking points or guidance 1202 that can be displayed on the device 134 of the companion device 104. The talking points or guidance 1202 can be provided to the user of the companion device 104 for use in guiding the user of the PDS display device 112.

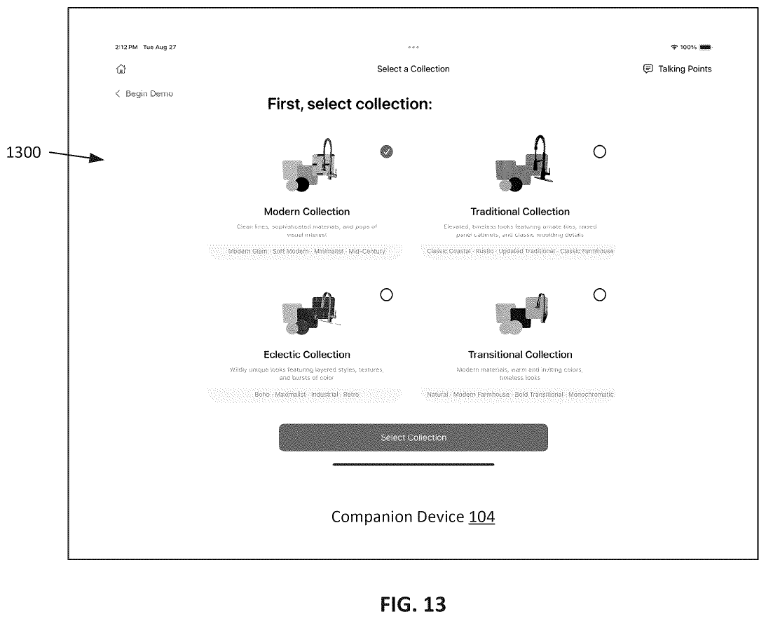

FIG. 13 shows a product collection selection screen 1300 for the companion device 104 that can be displayed on the device 134 of the companion device 104. The product collection selection screen 1300 can present options for selecting between different product collections for viewing and consideration by the user of the PDS display device 112. The different product collections can be formulated based on any suitable product attribute. For example, in the example product collection selection screen 1300 shown, the product collection options include a modern collection, a traditional collection, an eclectic collection, and a transitional collection. The companion device 104 and the PDS 102 can be configured so that the product collection selected via the product collection selection screen 1300 is employed by the PDS 102 to display the selected product collection selection by the PDS display device 112.

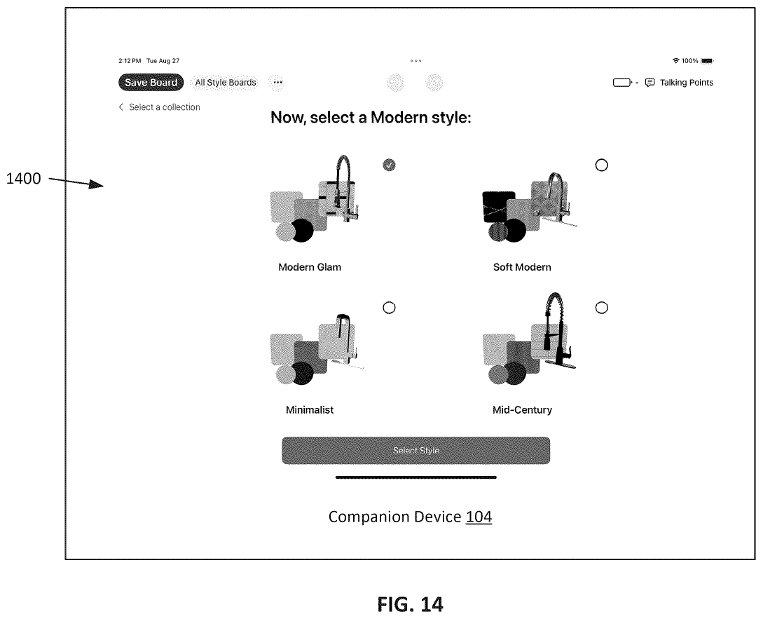

FIG. 14 shows a product style selection screen 1400 for the companion device 104 that can be displayed on the device 134 of the companion device 104. The product style selection screen 1400 presents a set of selectable style options for the product collection selected via the product collection selection screen 1300. For example, in the example product style selection screen 1400 shown, the product style options include “modern glam”, “soft modern”, “minimalist”, and “mid-century”.

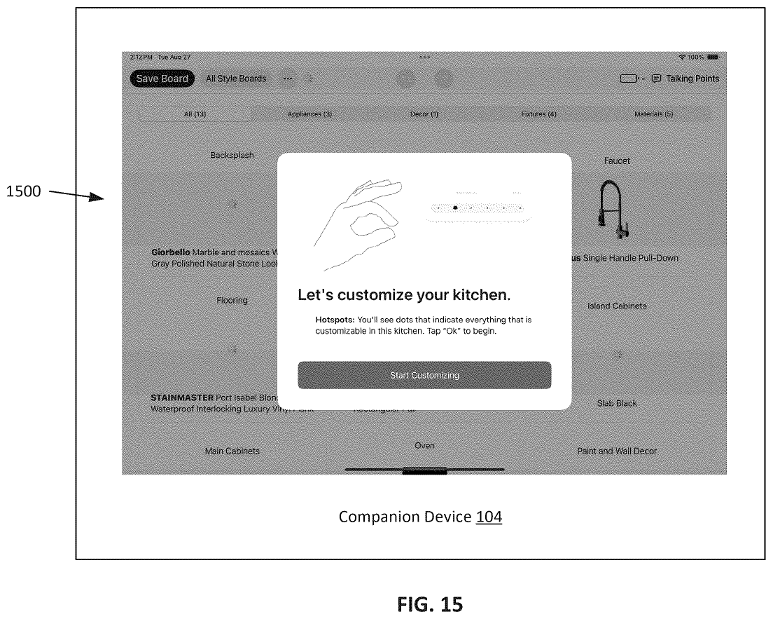

FIG. 15 shows a customization start screen 1500 for the companion device 104 that can be displayed on the device 134 of the companion device 104. The customization start screen 1500 can display an informational message for the user of the PDS display device 112 indicating that dots will be shown in the display of the product collection model to indicate all customizable aspects of the product collection model.

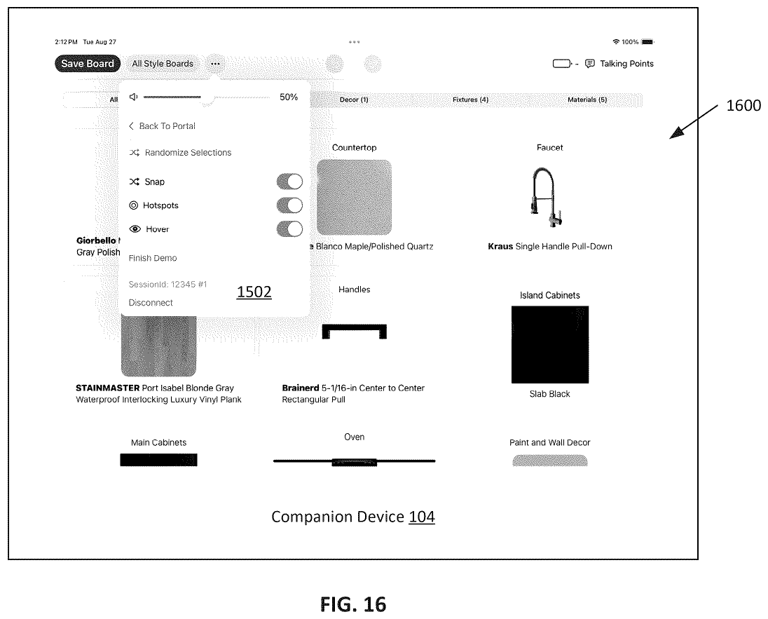

FIG. 16 shows a product selection screen 1600 (with an options menu 1602 displayed) that can be displayed on the device 134 of the companion device 104. The options menu 1602 can present configuration options that can be interacted with to cause the PDS 102 and/or the user interface of the PDS 102 displayed via the PDS display device 112 to be adjusted. For example, the options menu 1602 can enable the volume of the PDS display device 112 to be adjusted, a random selection to be made, adjust input recognized by the PDS display device 112 (e.g., whether the PDS display device 112 can recognize a finger snapping input), adjust which user interface elements are displayed (e.g., hotspots), and/or adjust how input is recognized by the PDS display device 112 (e.g., whether input by a user (e.g., via eye tracking) causes a second user interface to be displayed).

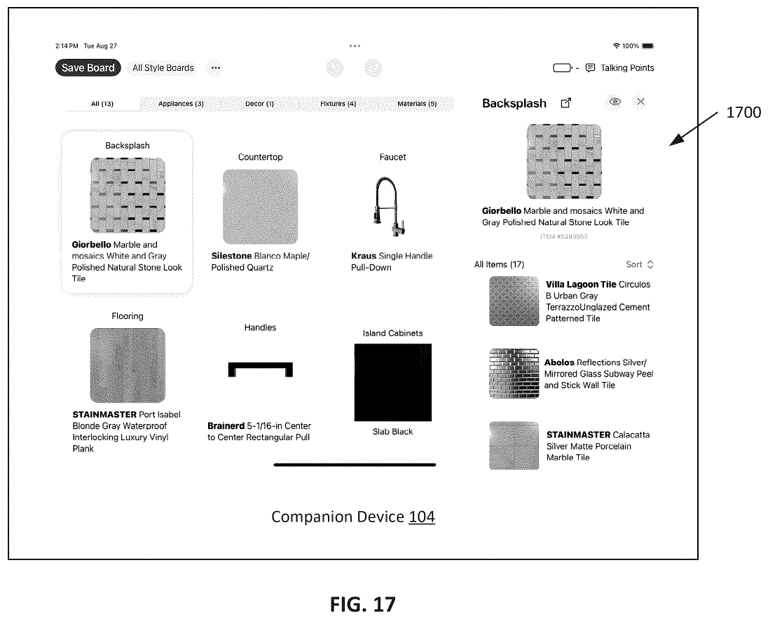

FIG. 17 shows a product selection screen 1700 (with the backsplash selected) for the companion device 104 that can be displayed on the device 134 of the companion device 104. The product selection screen 1700 can present a set of options that correspond to a set of options presented by the PDS display device 112. The set of options can be received from the PDS 102 or an indication of the set of options presented by the PDS 102 can be received from the PDS 102. Where an indication of the set of options is received from the PDS 102, the indication can include identifiers for the options, rather than full data represented by the identifiers, which can reduce network traffic. The indications can correspond to a set of options accessible by (e.g., stored on) the companion device 104.

The companion device 104 can present an indication of a user interface element that a user of the PDS display device 112 is interacting with. For example, the user of the PDS display device 112 may be interacting with a backsplash object, which causes the backsplash object to be presented by the companion device 104. Further, other backsplash objects may be presented by the companion device 104. If the companion device 104 receives input indicating a selection of a backsplash object, the selection may cause the PDS 102 to present an interface on the PDS display device 112 indicating the selection of the backsplash object.

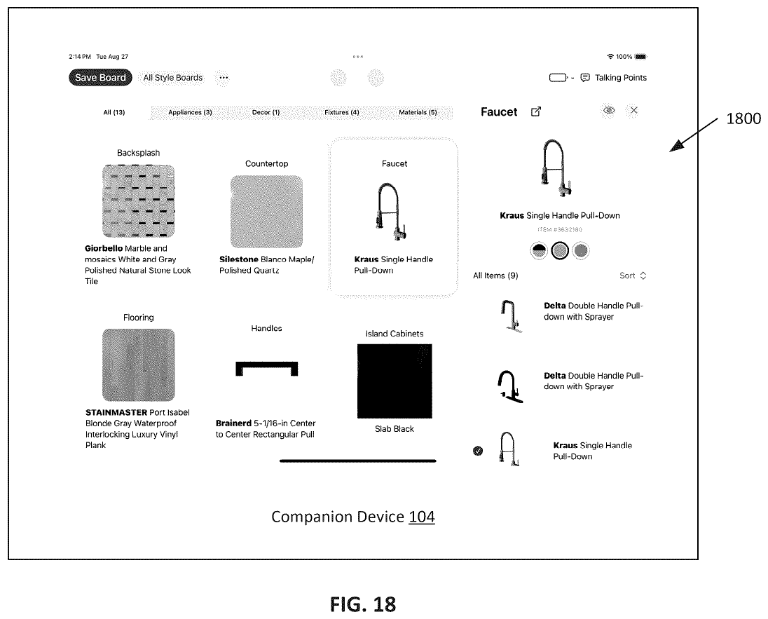

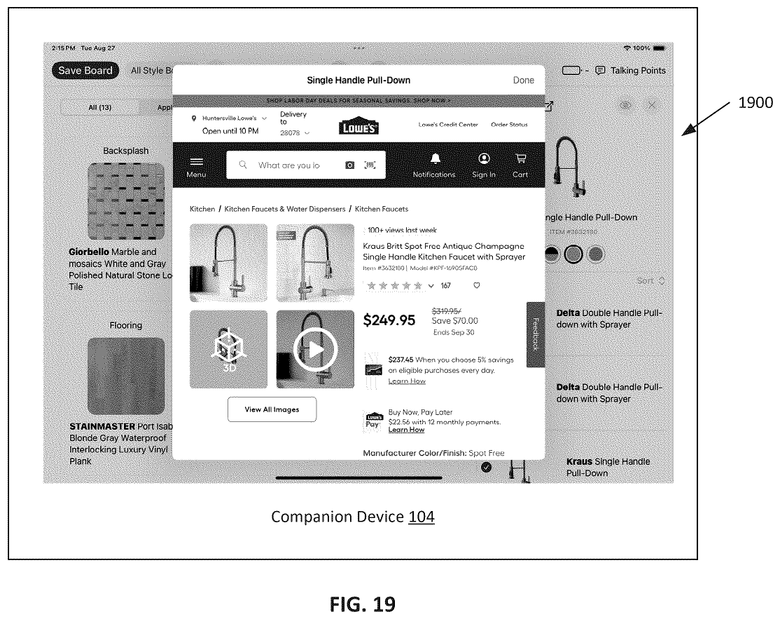

FIG. 18 shows a product selection screen 1800 (with the faucet selected) for the companion device 104 that can be displayed on the device 134 of the companion device 104. The product selection screen 1800 presents product options in a similar manner to the product selection screen 1700 of FIG. 17. One or more of the options (e.g., the currently selected option) may present sub-options that can be selected and/or present an indication of a link that can be interacted with. After the link is interacted with, an interface like the one illustrated in FIG. 19 can be presented.

FIG. 19 shows a product selection screen 1900 (with price and descriptive information for the faucet selected in FIG. 18) for the companion device 104 that can be displayed on the device 134 of the companion device 104. The price and description information displayed can be presented using a web browser and can correspond to a selected product.

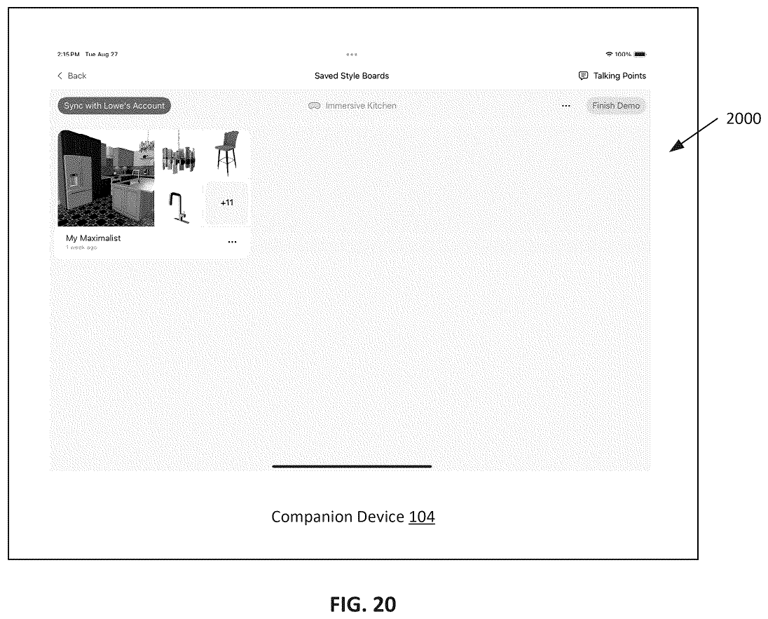

FIG. 20 shows a saved product selections screen 2000 for the companion device 104 that can be displayed on the device 134 of the companion device 104. The saved product selections screen 2000 can display a set of saved product selections. Each set of saved product selections can correspond to a collection of products selected using the PDS display device 112 and/or visualized via the PDS display device 112. The sets of saved product selections can be associated with a user account (e.g., a user account of a user of the PDS display device 112). Interacting with one of the sets of saved product selections can result in changes to the set of saved product selections.

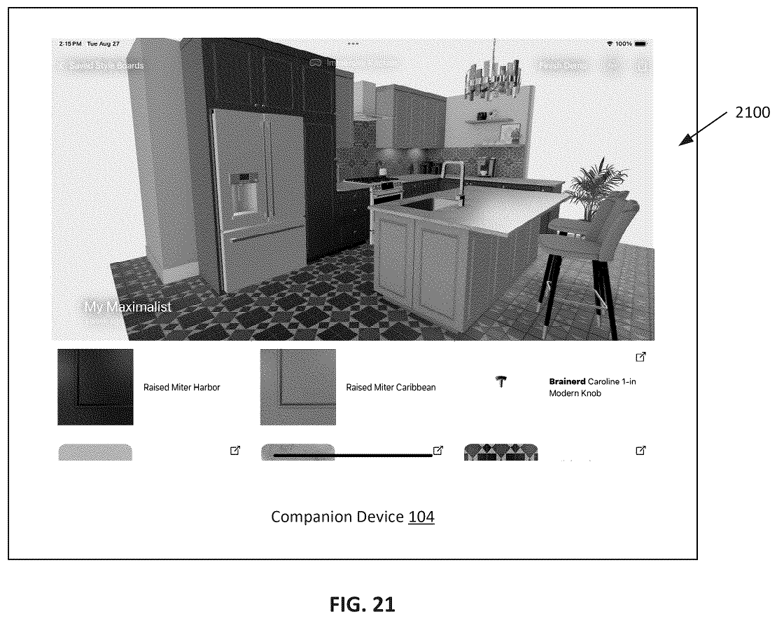

FIG. 21 shows a view screen 2100 (showing a product collection model of selected products) for the companion device 104 The view screen 2100 can be displayed on the device 134 of the companion device 104.

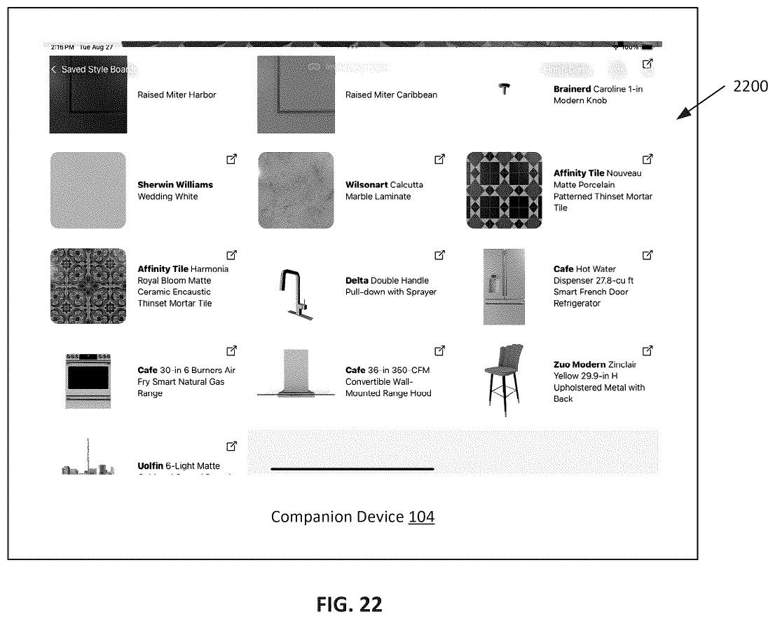

FIG. 22 shows a user interface screen 2200 (showing selectable product icons for currently selected products in the product collection model) for the companion device 104. The user interface screen 2200 can be displayed on the device 134 of the companion device 104.

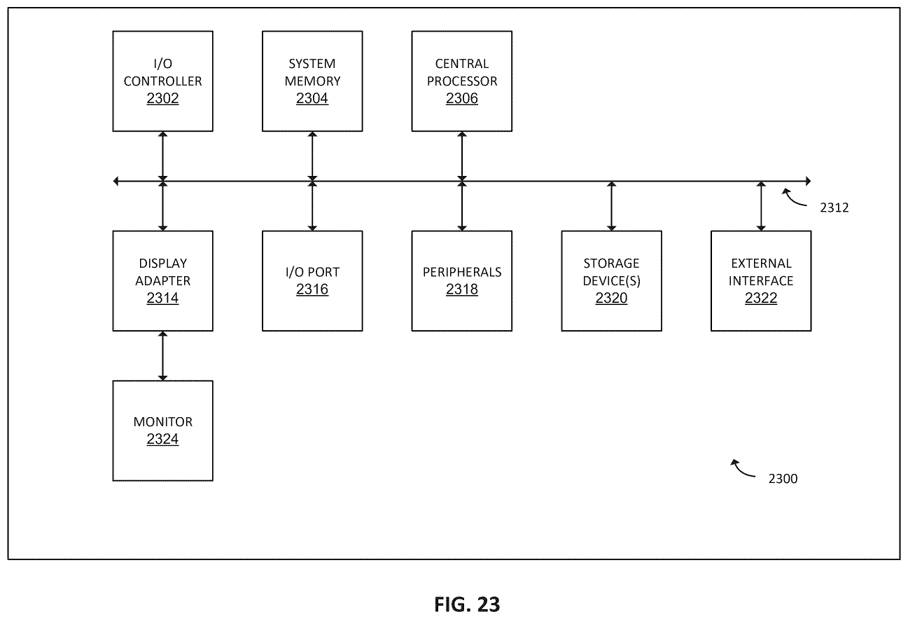

FIG. 23 shows an example computer system 2300, in accordance with the present disclosure. Each of the PDS 102, the companion device 104, and the mirroring device 108 can utilize any suitable subsystems. Examples of such subsystems are shown in FIG. 23 in the example computer system 2300.

The subsystems shown in the example computer system 2300 are interconnected via a system bus 2312. Additional subsystems such peripherals 2318 (e.g., a printer, a keyboard), storage device(s) 2320, monitor 2324 (e.g., a display screen, such as an LED), which is coupled to display adapter 2314, Driver Unit 1310, and others are shown. Peripherals 2318 and input/output (I/O) devices, which couple to I/O controller 2302, can be connected to the computer system by any number of means known in the art such as input/output (I/O) port 2316 (e.g., USB, Fire Wire®). As such, in an embodiment, peripherals 2318 may be connected to the system bus 2312 via an input/output (I/O) port 2316. For example, I/O port 2316 or external interface 2322 (e.g., Ethernet, Wi-Fi, etc.) can be used to connect computer system 2300 to a wide area network such as the Internet, a mouse input device, or a scanner. The interconnection via system bus 2312 allows the central processor 2306 to communicate with each subsystem and to control the execution of a plurality of instructions from system memory 2304 or the storage device(s) 2320 (e.g., a fixed disk, such as a hard drive, or optical disk), as well as the exchange of information between subsystems. The system memory 2304 and/or the storage device(s) 2320 may embody a computer readable medium. Any of the data mentioned herein can be output from one component to another component and can be output to the user.

A computer system can include a plurality of the same components or subsystems (e.g., connected by external interface 2322), by an internal interface, or via removable storage devices that can be connected and removed from one component to another component. In some embodiments, computer systems, subsystems, or apparatuses can communicate over a network. In such instances, one computer can be considered a client and another computer a server, where each can be part of the same computer system. A client and a server can each include multiple systems, subsystems, or components.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface. In some embodiments, computer systems, subsystems, or apparatuses can communicate over a network. In such instances, one computer can be considered a client and another computer a server, where each can be part of the same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor in a modular or integrated manner. As used herein a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

Any of the methods described herein may be totally or partially performed with a computer system including one or more processors, which can be configured to perform the steps. Thus, embodiments can involve computer systems configured to perform the steps of any of the methods described herein, potentially with different components performing a respective steps or a respective group of steps. Although presented as numbered steps, steps of methods herein can be performed at the same time or in a different order. Additionally, portions of these steps may be used with portions of other steps from other methods. Also, all or portions of a step may be optional. Additionally, any of the steps of any of the methods can be performed with modules, circuits, or other means for performing these steps.

The specific details of particular embodiments may be combined in any suitable manner without departing from the spirit and scope of embodiments of the invention. However, other embodiments of the invention may involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary. The use of “or” is intended to mean an “inclusive or,” and not an “exclusive or”unless specifically indicated to the contrary.

All patents, patent applications, publications, and descriptions mentioned above are herein incorporated by reference in their entirety for all purposes. None is admitted to be prior art.

1. A product selection and display system comprising:
a companion device comprising a companion device display, one or more companion device processors, and one or more companion device storage media storing companion device instructions executable by the one or more companion device processors to cause the companion device to:
display product selection options via the companion device;
receive companion device input designating one or more product selections via the companion device; and
generate and transmit one or more companion device product collection model control commands in response to the companion device input designating one or more product selections; and
a product display system (PDS) comprising a PDS display device, one or more PDS storage media storing PDS instructions, and one or more PDS processors, wherein the PDS display device comprises a PDS display, and wherein the PDS instructions are executable by the one or more PDS processors to cause the PDS to:
display a PDS display device view of a product collection model comprising a selection of products on the PDS display;
receive PDS input designating one or more PDS user product selections via the PDS display device; and
configure the product collection model from selected product models, wherein each of the selected product models is selected from a corresponding set of product models based on the PDS input designating one or more PDS user product selections and the one or more companion device product collection model control commands so that each of the companion device and the PDS display device can be used to independently configure the product collection model.

2. (canceled)

3. The system of claim 1, wherein the companion device instructions are executable by the one or more companion device processors and the PDS instructions are executable by the one or more PDS processors to implement a pairing process by which the companion device and the PDS are communicatively coupled.

4-6. (canceled)

7. The system of claim 1, wherein:
the PDS instructions are executable by the one or more PDS processors to:
generate selected product data indicative of a selected product of the product collection model selected by a user of the PDS display device; and
transmit the selected product data to the companion device; and
the companion device instructions are executable by the one or more companion device processors to display an indication of the selected product by the companion device display.

8. The system of claim 1, wherein the PDS instructions are executable by the one or more PDS processors to:
generate product collection model image data for the product collection model; and
transmit the product collection model image data to the companion device for use in displaying a companion device view of the product collection model on the companion device display.

9. The system of claim 1, wherein:
the PDS instructions are executable by the one or more PDS processors to transmit selectable product indication data indicating, for each selectable product of the product collection model, selectable products of the product collection model to the companion device; and
the companion device instructions are executable by the one or more companion device processors to display indications of the selectable products of the product collection model on the companion device display.

10. The system of claim 1, wherein the PDS instructions are executable by the one or more PDS processors to display indications of selectable products of the product collection model in the PDS display device view of the product collection model.

11. (canceled)

12. The system of claim 1, wherein the companion device instructions are executable by the one or more companion device processors to transmit product selection data for the product collection model for storage in a data storage device and in association with a customer account.

13. The system of claim 1, wherein the companion device instructions are executable by the one or more companion device processors to access and display price and descriptive data on the companion device display for a selected product of the product collection model.

14. (canceled)

15. The system of claim 1, wherein the PDS instructions are executable by the one or more PDS processors to change a viewpoint of the PDS display device view of the product collection model based on an PDS display device viewpoint instruction to change the viewpoint received via the PDS display device or a companion device viewpoint instruction to change the viewpoint received via the companion device.

16. The system of claim 1, wherein:
the PDS display device comprises a mixed reality system (MRS) headset; the MRS headset comprises an MRS headset display configured to display the PDS display device view of the product collection model;
the MRS headset comprises one or more image sensors configured to image a hand of a user of the MRS headset to generate corresponding hand image data; and
the PDS instructions are executable by the one or more PDS processors to:
process the hand image data to monitor for a finger snap of the user of the MRS headset; and
generate an input command in response to detecting the finger snap of the user of the MRS headset.

17. (canceled)

18. A product selection and display system comprising:
a companion device comprising a companion device display, one or more companion device processors, and one or more companion device storage media storing companion device instructions executable by the one or more companion device processors to cause the companion device to:
display product selection options via the companion device;
receive companion device input designating one or more product selections via the companion device; and
generate and transmit one or more companion device product collection model control commands in response to the companion device input designating one or more product selections;
a product display system (PDS) comprising a PDS display device, one or more PDS storage media storing PDS instructions, and one or more PDS processors, wherein the PDS display device comprises a PDS display, and wherein the PDS instructions are executable by the one or more PDS processors to cause the PDS to:
display a PDS display device view of a product collection model comprising a selection of products on the PDS display;
receive PDS input designating one or more PDS user product selections via the PDS display device; and
configure the product collection model from selected product models, wherein each of the selected product models is selected from a corresponding set of product models based on the PDS input designating one or more PDS user product selections and the one or more companion device product collection model control commands so that each of the companion device and the PDS display device can be used to independently configure the product collection model; and
a mirroring device comprising a mirroring device display, one or more mirroring device processors, and one or more mirroring device storage media storing mirroring device instructions executable by the one or more mirroring device processors to cause the mirroring device to display a mirroring device view of the product collection model on the mirroring device display.

19. (canceled)

20. The system of claim 18, wherein the mirroring device instructions are executable by the one or more mirroring device processors and the PDS instructions are executable by the one or more PDS processors to implement a pairing process by which the mirroring device and the PDS are communicatively coupled.

21. The system of claim 18, wherein the PDS instructions are executable by the one or more PDS processors to:
generate product collection model image data for the product collection model;
transmit the product collection model image data to the companion device for use in displaying a companion device view of the product collection model on the companion device display; and
transmit the product collection model image data to the mirroring device for use in displaying the mirroring device view of the product collection model on the mirroring device display.

22. The system of claim 18, wherein:
the mirroring device instructions are executable by the one or more mirroring device processors to cause the mirroring device to:
receive mirroring device input designating one or more product selections; and
generate and transmit one or more mirroring device product collection model control commands in response to the mirroring device input designating one or more product selections;
the PDS instructions are executable by the one or more PDS processors to:
receive the mirroring device product collection model control commands; and
select each product of the selection of products in the product collection model from the corresponding set of product models based on the companion device product collection model control commands, the PDS input designating one or more PDS user product selections, and the mirroring device product collection model control commands so that each of the companion device, the PDS display device, and the mirroring device can be used to independently configure the product collection model.

23. The system of claim 22, wherein:
the PDS instructions are executable by the one or more PDS processors to:
transmit selectable product indication data indicating, for each selectable product of the product collection model, selectable products of the product collection model to the companion device and the mirroring device; and
display indications of the selectable products of the product collection model in the PDS display device view;
the mirroring device instructions are executable by the one or more mirroring device processors to display indications of the selectable products of the product collection model in the mirroring device view; and
the companion device instructions are executable by the one or more companion device processors to display indications of the selectable products of the product collection model on the companion device display.

24. A method of facilitating product selection, the method comprising:
displaying, by a companion device, product selection options via a companion device display of the companion device;
receiving companion device input designating one or more product selections via the companion device;
generating and transmitting, by the companion device, one or more companion device product collection model control commands in response to the companion device input designating one or more product selections;
displaying, by a product display system (PDS) display device of a PDS, a PDS display device view of a product collection model of a selection of products;
receiving PDS input designating one or more PDS display device user product selections via the PDS display device; and
configuring the product collection model from selected product models, wherein each of the selected product models is selected from a corresponding set of product models based on the PDS input designating one or more PDS display device user product selections and the one or more companion device product collection model control commands so that each of the companion device and the PDS display device can be used to independently configure the product collection model.

25. (canceled)

26. The method of claim 24, further comprising communicatively pairing the companion device and the PDS.

27-29. (canceled)

30. The method of claim 24, further comprising:
generating selected product data indicative of a selected product of the product collection model selected by a user of the PDS display device;
transmitting the selected product data to the companion device; and
displaying an indication of the selected product by the companion device display.

31-38. (canceled)

39. The method of claim 24, wherein:
the PDS display device comprises a mixed reality system (MRS) headset; the MRS headset comprises an MRS headset display configured to display the PDS display device view of the product collection model; and
the MRS headset comprises one or more image sensors configured to image a hand of a user of the MRS headset to generate corresponding hand image data, and further comprising:
processing, by the PDS, the hand image data to monitor for a finger snap of the user of the MRS headset; and
generating, by the PDS, an input command in response to detecting the finger snap of the user of the MRS headset.

40. (canceled)

41. The method of claim 24, further comprising displaying a mirroring device view of the product collection model on a mirroring device.

42-46. (canceled)
